(19) United States
(12) Patent Application Publication
(10) Pub. No.: US 2009/0017834 A1
(43) Pub. Date: Jan. 15, 2009

(54) Apparatus and method for allocating connection identifier in communication system

(75) Inventors: Geun-Hwi Lim, Seongnam-si (KR); Won-Il Roh, Yongin-si (KR); Yong Chang, Seongnam-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/156,511

(22) Filed: Jun. 2, 2008

(30) Foreign Application Priority Data
Jun. 1, 2007 (KR) 10-2007-0054111

(51) Int. Cl. H04Q 7/20

(52) U.S. Cl. 455/450

(57) ABSTRACT

An apparatus and a method are disclosed for allocating a connection identifier by a base station in a communication system. The method includes: checking if a mobile station can use a private connection identifier; allocating at least one private connection identifier to the mobile station when the mobile station can use the private connection identifier, wherein the private connection identifier can be allocated to multiple mobile stations controlled by the base station, and at least two private connection identifiers allocated to each mobile station are not different from each other.

### CROSS-REFERENCE TO RELATED APPLICATION(S) AND CLAIM OF PRIORITY

This application claims the priority under 35 U.S.C. §119(a) of an application filed in the Korean Industrial Property Office on Jun. 1, 2007 and assigned Serial No. 2007-54111, the contents of which are hereby incorporated by reference.

### TECHNICAL FIELD OF THE INVENTION

The present invention relates to a communication system, and more particularly to an apparatus and a method for allocating a connection identifier in a communication system.

### BACKGROUND OF THE INVENTION

In the current communication systems, active research is in progress in order to provide users with high-speed services having various Qualities of Service (QoS). Especially, in the current next generation communication systems, active research is in progress in order to guarantee mobility and QoS for Broadband Wireless Access (BWA) communication systems.

In order to communicate with a Base Station (BS) in such a communication system, a Mobile Station (MS) should establish a connection with the Base Station (BS). The MS is allocated a Connection Identifier (CID) from the BS. The CID is used for identification of the connection between the MS and the BS. The MS is allocated a primary management CID and a basic CID used for transmission/reception of a control signal from the BS, at the time of initial connection to the network. Further, for transmission/reception of user data, the MS is allocated a transport CID.

In general, the CID allocated to the MS by the BS has a unique value within one BS. Further, when the MS moves from the service area of the BS to a service area of another BS, the MS should be allocated a new CID from the new BS.

Table 1 below shows typical CIDs used in a communication system.

TABLE 1

| CID | Value | Description |
|---|---|---|
| Ranging CID | 0x0000 | Used by SS and BS during ranging process. |
| Basic CID | 0x0001-m | The same value is assigned to both the DL and |
| | | UL connection. |
| Primary | m + 1-2m | The same value is assigned to both the DL and |
| management | | UL connection. |
| Transport CIDs, | 2m + 1-FE9F | For the secondary management connection, the |
| Secondary Mgt | | same value is assigned to both the DL and UL |
| CIDs | | connection. |
| Multicast CIDs | 0xFEA0-0xFEFE | For the downlink multicast service, the same |
| | | value is assigned to all MSs on the same channel |
| | | that participate in this connection. |
| AAS initial | 0xFEFF | A BS supporting AAS shall use this CID when |
| ranging CID | | allocating an AAS Ranging period (using AAS |
| | | Ranging Allocation IE). |
| Multicast | 0xFF00-0xFFF9 | A BS may be included in one or more multicast |
| polling CIDs | | polling groups for the purposes of obtaining |
| | | bandwidth via polling. These connections have |
| | | no associated service flow. |
| Normal mode | 0xFFFA | Used in DL-MAP to denote bursts for transmission |
| multicast CID | | of DL broadcast information to normal mode MS. |
| Sleep mode | 0xFFFB | Used in DL-MAP to denote bursts for transmission |
| multicast CID | | of DL broadcast information to Sleep mode MS. |
| | | May also be used in MOB_TRE-IND messages. |
| Idle mode | 0xFFFC | Used in DL-MAP to denote bursts for transmission |
| multicast CID | | of DL broadcast information to Idle mode MS. |
| | | May also be used in MOB_PAG-ADV message. |
| Fragmentable | 0xFFFD | Used by the BS for transmission of management |
| Broadcast CID | | broadcast information with fragmentation. The |
| | | fragment sub header shall use 11-bit long FSN |
| | | on this connection. |
| Padding CID | 0xFFFE | Used for transmission of padding information |
| | | by SS and BS. |
| Broadcasting CID | 0xFFFF | Used for broadcast information that is |
| | | transmitted on a downlink to all SS. |

In relation to each of the basic CID, the primary management CID, and the transport CID, when an MS moves to a service area of a new BS (target BS) through handover, the CID of the MS may interfere with a CID of another MS belonging to the target BS. At this time, the target BS should allocate new CIDs to the MS.

As described above, the target BS performs transport CID update according to movement of the MS. To this end, the target BS transmits transport CID update Type-Length-Value (TLV) to the MS.

The BS should transmitmay bytes of TLV to the MS in order to update one CID and during the handover, it can cause delay to update the CID newly.

### SUMMARY OF THE INVENTION

As described above, the BS may need to update a CID of an MS due to some reasons, such as handover. Such an update requires consumption of as much resources as the number of the connections of the MS.

Accordingly, the present invention has been made to solve the above-mentioned problems occurring in the prior art, and the present invention provides an apparatus and a method for allocating a connection identifier in a communication system.

Also, the present invention provides an apparatus and a method for connection identifier update without wasting resources.

Furthermore, the present invention provides an apparatus and a method for allocating a connection identifier according to movement of a mobile station in a communication system.

Moreover, the present invention provides an apparatus and a method for allocating a connection identifier with a minimum quantity of resources consumed for update of the connection identifier in a communication system.

In accordance with an aspect of the present invention, there is provided a method of allocating a connection identifier by a base station in a communication system, the method including the steps of: checking if a mobile station can use a private connection identifier; and allocating at least one private connection identifier to the mobile station when the mobile station can use the private connection identifier, wherein the private connection identifier can be repeatedly allocated to multiple mobile stations controlled by the base station, and at least two private connection identifiers allocated to each mobile station are not different from each other. In accordance with another aspect of the present invention, there is provided a method of being allocating a connection identifier by a mobile station in a communication system, the method including the steps of: informing a Base station if a mobile station can use a private connection identifier; receiving the private connection identifier from the base station, wherein the private connection identifier can be repeatedly allocated to multiple mobile stations controlled by the base station, and at least two private connection identifiers allocated to each mobile station are not different from each other.

In accordance with another aspect of the present invention, there is provided an apparatus for allocating a connection identifier in a communication system, the apparatus including: a mobile station; and a base station for checking if the mobile station can use a private connection identifier, and allocating at least one private connection identifier to the mobile station when the message indicates that the mobile station can use the private connection identifier, wherein the private connection identifier can be allocated to multiple mobile stations controlled by the base station, and at least two private connection identifiers allocated to each mobile station are not different each other.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior uses, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates allocation of a private transport CID in a communication system according to an embodiment of the present invention;

FIG. 2 is a signal flow diagram illustrating allocation of a private transport CID in a communication system according to an embodiment of the present invention;

FIG. 3 is a signal flow diagram illustrating allocation of a private transport CID in a communication system according to an embodiment of the present invention;

FIG. 4 is a signal flow diagram illustrating a handover process in the case of using a transport CID in a communication system according to an embodiment of the present invention; and

FIG. 5 is a signal flow diagram illustrating a handover process in the case of using a private transport CID in a communication system according to an embodiment of the present invention.

### DETAILED DESCRIPTION OF THE INVENTION

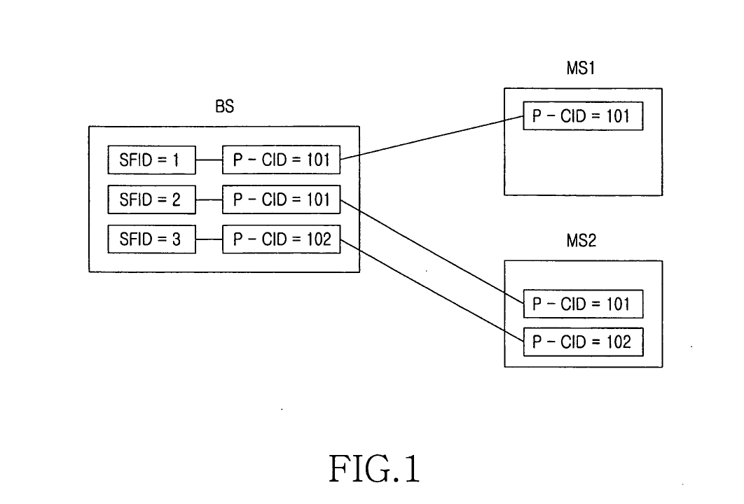

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

The present invention a private transport CID, which is a specific CID used within only one MS, will be described.

FIG. 1 illustrates allocation of a private transport CID in a communication system.

Referring to FIG. 1, the communication system includes a BS, a MS1, and a MS2, and a MS3.

It is assumed that the MS1 and the MS3 and the MS3 are MSs using a communication service from the BS. FIG. 1 shows three service flows provided by the BS, and each of the three service flows is allocated a specific CID. The CID allocated to each MS by the BS is a Private CID (P-CID) proposed by the present invention.

If the first Mobile Station MS uses the first service flow, the BS allocates “1” to an Service Flow Identifier (SFID) according to use of the first service flow (SFID=1).

If the MS2 uses the second service flow, the BS allocates “2” to an SFID according to use of the second service flow (SFID=2). Further, if the MS3 uses the third service flow, the BS allocates “3” to an SFID according to use of the third service flow (SFID=3).

The BS allocates “101” to the private transport CID (transport P-CID=101) for the SFID (SFID=1) of the MS1. Further, the BS allocates “101” to the private transport CID (transport P-CID=101) for the SFID (SFID=2) of the MS2, and the BS allocates “102” to the private transport CID (transport P-CID=102) for the SFID (SFID=3) of the MS3.

As noted from the above description, the same private transport CID is allocated to MSs using different service flows, and different MSs communicating with the BS use the same private transport CID. However, the MS1 and the MS2 are actually connected through different service flows.

That is to say, although the private transport CID has a unique value in view of each MS, multiple MSs may have the same private transport CID in view of one cell. However, even when the same private transport CID has been allocated to multiple MSs, the BS is aware that there are different SFIDs corresponding to the private transport CID. The MSs using the private transport CID can keep on using the existing private transport CID in using a service from a new BS even after the handover to another BS. Therefore, it is unnecessary for an MS using the private transport CID to perform a separate CID update.

Meanwhile, in order to use a private transport CID, the BS may allocate a resource for data burst transmission/reception to each MS. That is, the BS indicates which data burst an MS may receive, by inserting a basic CID or an RCID (Reduced CID) into an HARQ MAP IE corresponding to data burst allocation information. Since each MS possesses a specific basic CID (RCID), the MS can receive a data burst corresponding to the MS itself. Therefore, the corresponding MS does not receive a data burst transmitted to another MS. Since all MAP IEs for uplink data burst transmission include a basic CID, the uplink transmission has no problem. The RCID refers to a Reduced CID, which has a size of eight (8) bits or twelve (12) bits while the basic CID generally has a size of sixteen (16) bits.

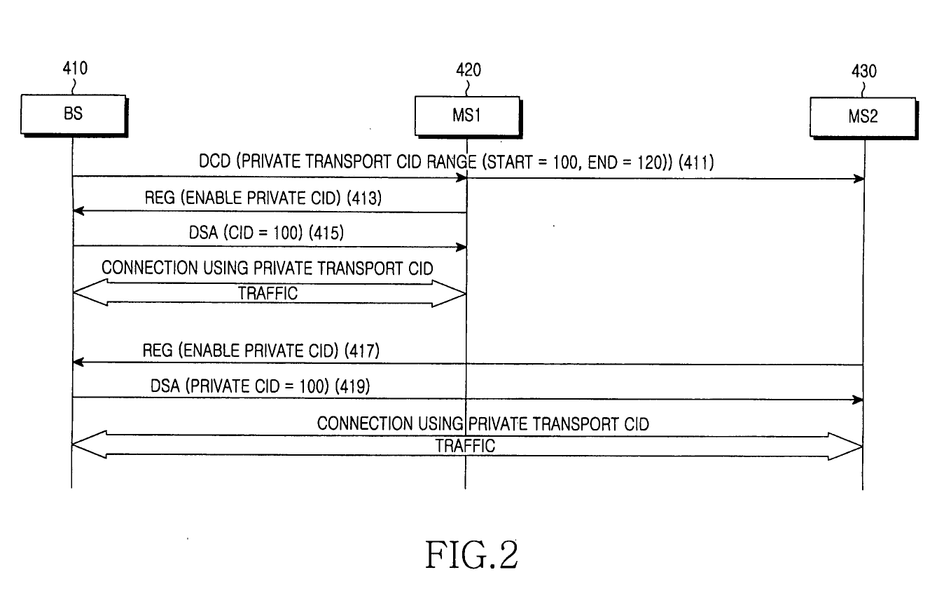

FIG. 2 is a signal flow diagram illustrating allocation of a private transport CID in a communication system according to an embodiment of the present invention.

Referring to FIG. 2, the communication system includes a BS 410, a MS1 420, and a MS2 430.

The BS 410 broadcasts a private transport CID information message having a specific value within each MS through, for example, a Downlink Channel Descriptor (DCD) message in order to use a private transport CID (step 411).

The private transport CID information indicates a range of the CID value which the private transport CID may have. For example, the private transport CID value can be allocated by using a part of the transport CID value.

Some of the transport CIDs (2m+1 to FE9F, wherein m refers to a value that can be optionally set by the BS) can be allocated to private transport CIDs. At this time, the BS may not use the CIDs, which have been allocated to the private transport CIDs, as the transport CIDs. As a result, it is possible to prevent collision between an MS using the transport CID and an MS using the private transport CID.

The range of the private transport CID can be inserted in a form of Type-Length-Value (TLV) into a DCD message. Examplary, table 2 below shows a private transport CID TLV inserted in a DCD message.

TABLE 2

| | Type | Length | Value | |
|---|---|---|---|---|
| Name | (1 byte) | (1 byte) | (4 byte) | Scope |
| Private | NNN | 2 | Bit#0-15: Start range of | DCD |
| Transport | | | Private Transport CID | |
| CID range | | | Bit#16-31: End range of Private | |
| | | | Transport CID | |

The TLV shown in Table 2 is included in a message (e.g. DCD message) periodically broadcasted by the BS, and an MS having received the broadcasted message can identify the private transport CID.

The private transport CID range included in the DCD message may have, for example, a start CID value of 100 and a final CID value of 120.

Upon receiving the DCD message, the MS1 420 transmits a first message, which indicates if the MS1 420 can use the private transport CID, to the BS 410 (step 413). The first message may be a registration (REG) message, a ranging message, or an MS basic capability message.

Examplary, table 3 below shows a TLV field indicating if it is possible to use the private transport CID.

TABLE 3

| | Type | Length | Value | |
|---|---|---|---|---|
| Name | (1 byte) | (1 byte) | (1 byte) | Scope |
| Private | NNN | 1 | Bit#0: 1 - Enable, 0 - Disable | SBC or |
| Transport | | | | REG |
| CID | | | | |
| Enable | | | | |

Upon receiving the first message including the TLV, the BS 410 can report to the MS1 420 that the MS1 420 can use the private transport CID.

When it is possible to allocate a private transport CID to the MS1 420, the BS allocates the private transport CID to the MS1 420 through a Dynamic Service Addition (DSA) message (step 415).

The BS 410 transmits a private transport CID having a specific identifier within the MS1 420 to the MS1 420. The following description is based on an assumption that the private transport CID is “100.” Upon receiving the DSA message, the MS1 420 compares the allocated CID value with the private transport CID range received in step 411, thereby determining if the allocated CID is a private transport CID or a transport CID.

Thereafter, the BS 410 and the MS1 420 can exchange data by using a private transport CID.

Next, when the MS2 430 has received the DCD message, the MS2 430 determines if the MS2 430 can use the private transport CID, by using the first message transmitted to the BS 410 (step 417).

The MS2 430 can transmit an SBC message or an REG message, which indicates if it is possible to support the private transport CID, to the BS 410. The private transport CID enable TLV for transmitting a message indicating if it is possible to use the private transport CID from the MS2 430 to the BS 410 has been described above with reference to Table 3, so a detailed description thereof will be omitted here.

From the private transport CID availability confirmation message, the BS 410 can confirm that the BS 410 can allocate a private transport CID to the MS2 430.

When it is possible to allocate a private transport CID to the MS2 430, the BS 410 allocates the private transport CID to the MS2 430 through a DSA message (step 419).

The private transport CID allocated by the BS 410 overlaps with the private transport CID possessed by each MS, and the same private transport CID can be allocated to both the MS1 420 and the MS2 430. Further, through the DSA message, the MS2 430 can compare the allocated CID with the private transport CID received in step 411, so as to determine if the allocated CID is a private transport CID or a transport CID.

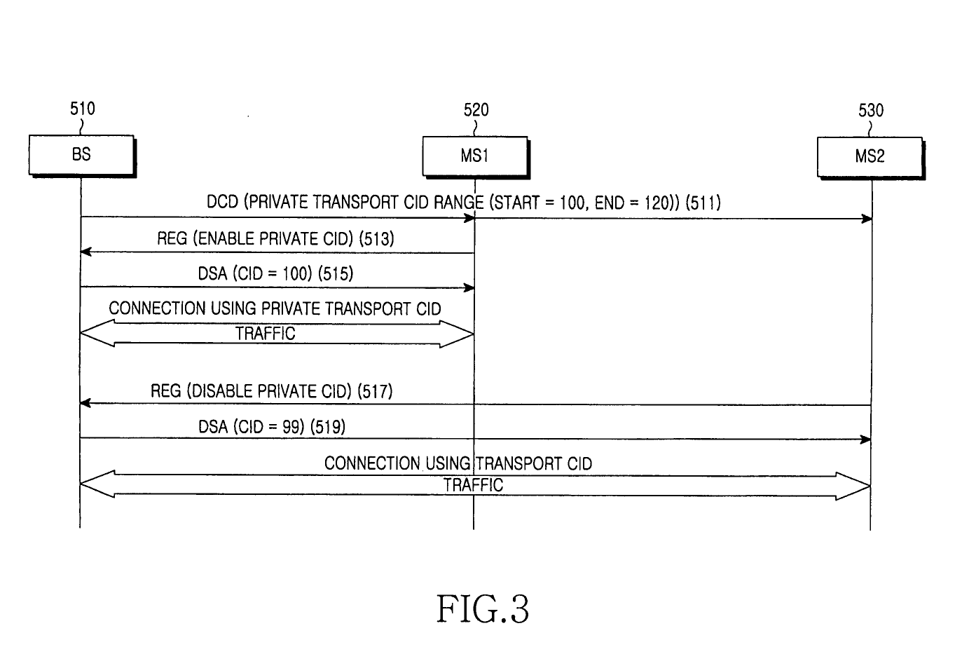

FIG. 3 is a signal flow diagram illustrating allocation of a private transport CID in a communication system according to an embodiment of the present invention.

Referring to FIG. 3, the communication system includes a BS 510, a MS1 520, and a MS2 530.

The BS 510 broadcasts a private transport CID information message having a specific value within each MS through, for example, a DCD message in order to use a private transport CID (step 511).

Upon receiving the DCD message, the MS1 520 transmits a first message, which indicates if the MS1 520 can use the private transport CID, to the BS 510 (step 513).

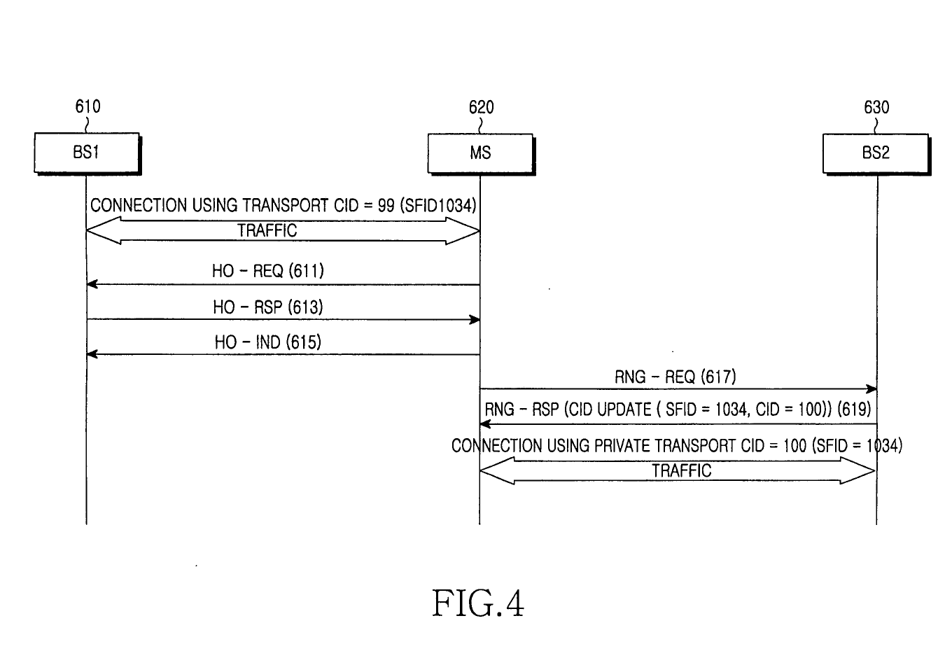

Steps 511 to 513 are the same as steps 411 to 413 of FIG. 4, so a detailed description thereof is omitted here.

In order to transmit a data burst to each MS, the BS uses an HARQ DL MAP IE including a basic CID or an RCID. In the case of uplink, the BS uses a UL MAP IE or a UL HARQ MAP IE in order to receive a data burst from the MS.

Thereafter, the BS 510 and the MS1 520 can exchange data by using a private transport CID.

Next, when the MS2 530 has received the DCD message, the MS2 530 transmits the first message to the BS 510 in order to report that the MS2 530 is unable to use the private transport CID (step 517).

The MS2 530 can transmit an SBC message or an REG message, which indicates if it is possible to support the private transport CID, to the BS 510.

From the private transport CID availability confirmation message, the BS 510 can confirm that the BS 510 cannot allocate a private transport CID to the MS2 530.

When it is possible to allocate a transport CID to the MS2 530, the BS 510 allocates the transport CID to the MS2 530 through a DSA message (step 519).

The BS transmits the transport CID to the MS2 530. Further, upon receiving the DSA message, the MS2 530 can compare the allocated CID with the private transport CID received in step 511, so as to determine if the allocated CID is a private transport CID or a transport CID.

As described above, the BS allocates a transport CID to an MS that does not support the private transport CID.

FIG. 4 is a signal flow diagram illustrating a handover process in the case of using a transport CID in a communication system according to an embodiment of the present invention.

Referring to FIG. 4, the communication system includes a first Base Station (BS1) 610, a Mobile Station (MS) 620, and a second Base Station (BS2) 630.

The MS 620 is connected with the BS1 610 by using a transport CID, which has a value of, for example, 99. It is assumed that an SFID corresponding to the transport CID is 1034.

When the MS 620 detects a necessity of handover to a new BS (i.e. target BS) due to movement of the MS 620, etc., the MS 620 transmits a handover request (HO-REQ) message to the BS1 610 (step 611).

In response to the handover request from the MS 620, the BS1 610 transmits a handover response (HO-RSP) message reporting that the MS 620 is allowed to handover (step 613).

Upon receiving the handover response message, the MS 620 transmits a handover indication (HO-IND) message indicating change of the service connection point from the BS1 610 to the BS2 630, that is, indicating that it will handover from the BS1 610 to the BS2 630 (step 615).

Then, the MS 620 transmits a ranging request (RNG-REQ) message to the BS2 630 (step 617).

In response to the ranging request message, the BS2 630 transmits a ranging response (RNG-RSP) message to the MS 620 (step 619). As the MS 620 newly enters the BS2 630, the BS2 630 can insert a private transport CID in the ranging response message transmitted to the MS 620. If the MS 620 uses the existing SFID, which has been used between the MS 620 and the BS1 610 and has a value of 1034, the BS2 630 allocates a private transport CID, which has a value of, for example, 100, for communication with the MS 620. It is selected from a range of the CID value which the private transport CID may have. For example, the private transport CID value can be allocated by using a part of the transport CID value.

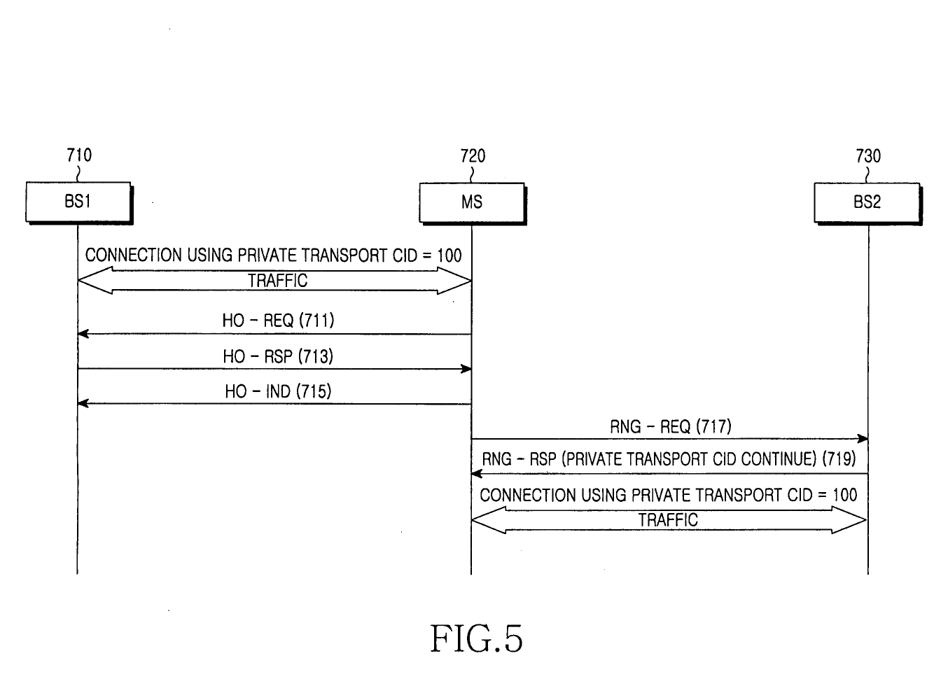

According to the handover, the MS 620 performs a process of being allocated the private transport CID. Hereinafter, a handover process in the case of using the private transport CID will be described with reference to FIG. 5.

FIG. 5 is a signal flow diagram illustrating a handover process in the case of using a private transport CID in a communication system according to an embodiment of the present invention.

Referring to FIG. 5, the communication system includes a BS1 710, MS 720, and a BS2 730.

The MS 720 is connected with the BS1 710 by using a private transport CID, which has a value of, for example, 100.

When the MS 720 detects a necessity of handover to a new BS, i.e. BS2 730, due to movement of the MS 720, etc., the MS 720 transmits a handover request (HO-REQ) message to the BS1 710 (step 711).

In response to the handover request from the MS 720, the BS1 710 transmits a handover response (HO-RSP) message reporting that the MS 720 is allowed to handover (step 713).

Upon receiving the handover response message, the MS 720 transmits a handover indication (HO-IND) message indicating that it will handover from the BS1 710 to the BS2 730 (step 715).

Then, the MS 720 transmits a ranging request (RNG-REQ) message for communication with the BS2 730 to the BS2 730 (step 717).

In response to the ranging request message, the BS2 730 transmits a ranging response (RNG-RSP) message to the MS 720 (step 719). If the BS2 730 supports use of private transport CIDs by the MS 720 and supports connection using all private transport CIDs allocated to the MS 720, the BS2 730 transmits a private transport CID continue TLV recommending continuous use of the existing private transport CIDs having been used by the MS 720. The MS 720 can receive the private transport CID continue TLV through the ranging response message, etc. The MS 720 receives a message indicating if it can use the private transport CID from the target BS2 730.

When the MS 720 has received the private transport CID continue TLV, the MS 720 uses the existing private transport CIDs having been used between the previous BS1 710 and the MS 720 as it is. That is, the MS 720 communicates with the BS2 730 by using the existing private transport CID having a value of 100.

If the BS2 730 cannot support a private transport CID or cannot support private transport CIDs for all connections of the MS 720, the BS2 730 performs CID update by using the transport CID as shown in FIG. 4.

Then, the MS 720 performs a process of being allocated a new transport CID according to handover. If the MS 720 can identify the private transport CID through the BS2 730 in advance, the MS 720 can transmit/receive data even without receiving the private transport CID continue TLV.

In other words, by using the private transport CID proposed by the present invention, an MS can perform communication by using an already allocated private transport CID even without performing a separate CID update process.

In a communication system according to the present invention as described above, a BS allocates a specific transport CID, which is unique within each MS, to each MS. Since the private transport CID can be shared by multiple MSs within the entire system, a transport CID update process is not indispensable. Therefore, it is possible to prevent wasting of resources due to the transport CID update process. Further, it is unnecessary to allocate a new transport CID due to movement of an MS even in the case of handover, which allows fast handover. Moreover, use of the private transport CID allows communication through additional allocation of a basic CID and a primary management CID.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of allocating a connection identifier by a base station in a communication system, the method comprising the steps of:
checking if a mobile station can use a private connection identifier;
allocating at least one private connection identifier to the mobile station when the mobile station can use the private connection identifier,
wherein the private connection identifier can be allocated to multiple mobile stations controlled by the base station, and at least two private connection identifiers allocated to each mobile station are not different from each other.

2. The method of claim 1, wherein the step of checking if a mobile station can use a private connection identifier comprising:
broadcasting the private connection identifier information; and
receiving a message from the mobile station having received the private connection identifier information, the message indicating if the mobile station can use a private connection identifier.

3. The method of claim 1, wherein the private connection identifier is a transport connection identifier allocated according to each service flow.

4. The method of claim 1, wherein the private connection identifier information is included in a broadcasted Downlink Channel Descriptor (DCD) message.

5. The method of claim 1, wherein the private connection identifier information has a value range that the private connection identifier can have.

6. The method of claim 1, wherein said at least one private connection identifier is allocated through a Dynamic Service Allocation (DSA) message.

7. A method of being allocating a connection identifier by a mobile station in a communication system, the method comprising the steps of:
informing a Base station if a mobile station can use a private connection identifier;
receiving the private connection identifier from the base station, wherein the private connection identifier can be allocated to multiple mobile stations controlled by the base station, and at least two private connection identifiers allocated to each mobile station are not different form each other.

8. The method of claim 7, wherein the private connection identifier is allocated to each service flow.

9. The method of claim 7, wherein the message indicating that the mobile station can use the private connection identifier is at least one of a registration message and a mobile station basic capability message.

10. The method of claim 7, wherein the step of informing a base station if a mobile station can use a private connection identifier comprising:
receiving private connection identifier information from a base station; and
transmitting a message to the base station when the mobile station can use a private connection identifier, the message indicating that the mobile station can use the private connection identifier based on the private connection identifier information.

11. The method of claim 7, when the mobile station handovers to a target base station, the method further comprising the steps of:
transmitting a ranging request message to the target base station;
receiving a ranging response message from the target base station; and
communicating with the target base station using the private connection identifier, when the ranging response message indicates that the mobile station can use the private connection identifier.

12. An apparatus for allocating a connection identifier in a communication system, the apparatus comprising:
a mobile station; and
a base station for checking if the mobile station can use a private connection identifier, and allocating at least one private connection identifier to the mobile station when the mobile station can use the private connection identifier,
wherein the private connection identifier can be repeatedly allocated to multiple mobile stations controlled by the base station, and at least two private connection identifiers allocated to each mobile station are not different form each other.

13. The apparatus of claim 12, wherein the private connection identifier is a transport connection identifier allocated according to each service flow.

14. The apparatus of claim 12, wherein the base station broadcasts a DCD message including the private connection identifier information.

15. The apparatus of claim 12, wherein the private connection identifier information has a value range that the private connection identifier can have.

16. The apparatus of claim 12, wherein said at least one private connection identifier is allocated through a DSA message.

17. The apparatus of claim 12, wherein the mobile station receives private connection identifier information from a base station, transmits a message to the base station when the mobile station can use a private connection identifier, the message indicating that the mobile station can use the private connection identifier, and is allocated the private connection identifier from the base station.

18. The apparatus of claim 17, wherein the message indicating that the mobile station can use the private connection identifier is at least one of a registration message and a mobile station basic capability message.

19. The apparatus of claim 12, wherein the base station broadcasts the private connection identifier information, and receives a message from the mobile station having received the private connection identifier information, the message indicating if the mobile station can use a private connection identifier.

20. The apparatus of claim 12, wherein mobile station info rms the base station if the mobile station can use the private connection identifier, and receives the private connection identifier allocated from the base station, wherein the private connection identifier can be allocated to multiple mobile stations controlled by the base station, and at least two private connection identifiers allocated to each mobile station are not different from each other.

21. The apparatus of claim 12, wherein the mobile station receives the private connection identifier information from the base station; and transmits a message to the base station when the mobile station can use a private connection identifier, the message indicating that the mobile station can use the private connection identifier based on the private connection identifier information.

22. The apparatus of claim 12, wherein the mobile station transmits a ranging request message to a target base station, receives a ranging response message from the target base station, and communicates with the target base station using the private connection identifier, when the ranging response message indicates that the mobile station can use the private connection identifier.
